(19) United States
(12) Patent Application Publication
(10) Pub. No.: US 2024/0375556 A1
(43) Pub. Date: Nov. 14, 2024

(54) SEAT CONTROL APPARATUS AND METHOD

(71) Applicants: HYUNDAI MOTOR COMPANY, Seoul (KR); KIA CORPORATION, Seoul (KR)

(72) Inventors: Kug Hun Han, Seoul (KR); Sang Soo Lee, Hwaseong-si (KR); Sang Hark Lee, Incheon (KR); Dong Hoon Lee, Hwaseong-si (KR); Mun Seung Kang, Suwon-si (KR); Deok Soo Lim, Hwaseong-si (KR); Yo Han Kim, Ansan-si (KR)

(73) Assignees: HYUNDAI MOTOR COMPANY, Seoul (KR); KIA CORPORATION, Seoul (KR)

(21) Appl. No.: 18/500,469

(22) Filed: Nov. 2, 2023

(30) Foreign Application Priority Data
May 14, 2023 (KR) 10-2023-0062092

(51) Int. Cl. B60N 2/02

(52) U.S. Cl. CPC B60N 2/0278; B60N 2/0248; B60N 2/0256

(57) ABSTRACT

A seat control apparatus includes a sensor device, a driving device, a memory, and a control device. The control device is configured to: identify an intent of a user getting on a host vehicle by using the sensor device; identify a state of a seat corresponding to the user, when the intent of the user satisfies a specified condition; store the identified state of the seat in the memory; and control at least one of a slide location of the seat, a tilt location of the seat, a legrest location of the seat, or a combination thereof of the seat by using the driving device based on the state of the seat.

### CROSS-REFERENCE TO RELATED APPLICATION

This application claims the benefit of and priority to Korean Patent Application No. 10-2023-0062092, filed on May 14, 2023, the entire contents of which are incorporated herein by reference.

### TECHNICAL FIELD

The present disclosure relates to a seat control apparatus and a method thereof. More particularly, the present disclosure relates to a technology for controlling a state of a seat based on a user's intent.

### BACKGROUND

As technology advances, various components within a vehicle may be operatively connected to one another. A vehicle control apparatus may quickly and accurately provide various functions by performing cooperative control among components for a user's convenience.

In particular, to enhance the convenience of the user who boards a seat in a vehicle, a function of adaptively controlling the state (or location) of the seat is being progressively developed. For example, in a situation where the user gets on or gets off a host vehicle, a technology for enhancing the user's convenience by adaptively changing a location or state of the seat is being developed.

However, as the type of device (e.g., a driving device, and the like) capable of changing the state of a seat is restrictively provided, it becomes difficult to provide a seating state that makes the user's entry and exit as comfortable as possible.

### SUMMARY

The present disclosure has been made to solve the above-mentioned problems occurring in the prior art while advantages achieved by the prior art are maintained intact.

An aspect of the present disclosure provides a seat control apparatus including a sensor device, a driving device, a memory, and a control device. Another aspect of the present disclosure provides a seat control method.

An aspect of the present disclosure provides a seat control apparatus that identifies at least one user's intent to get on and/or off the host vehicle based on data obtained by using a sensor device. The seat control apparatus also controls a location (or state) of at least one seat based on the identification result. Another aspect of the present disclosure provides a method thereof.

An aspect of the present disclosure provides a seat control apparatus that controls a location of the seat such that the user is capable of easily getting off the host vehicle, after identifying and storing a real-time state of a seat corresponding to the user. This is achieved when the user's exit intent is identified. Another aspect of the present disclosure is a seat control method.

An aspect of the present disclosure provides a seat control apparatus that restores a location of the seat by using at least part of the pre-stored state of the seat when the user's entry intent is identified, and a method thereof.

The technical problems to be solved by the present disclosure are not limited to the aforementioned problems. Furthermore, any other technical problems not mentioned herein should be clearly understood from the following description by those having ordinary skill in the art to which the present disclosure pertains.

According to an aspect of the present disclosure, a seat control apparatus includes a sensor device, a driving device, a memory configured to store instructions, and a control device electrically connected to the sensor device, the driving device, and the memory. The instructions, when executed by the control device, cause the seat control apparatus to: identify the intent of a user getting on a host vehicle by using the sensor device; and identify a state of a seat corresponding to the user, when the intent of the user satisfies a specified condition. The instructions, when executed by the control device, may further cause the seat control apparatus to store the identified state of the seat in the memory. Additionally, the instructions, when executed by the control device, may cause the seat control apparatus to control at least one of a slide location of the seat, a tilt location of the seat, a legrest location of the seat, or a combination thereof by using the driving device based on the state of the seat.

According to an embodiment, the instructions, when executed by the control device, may cause the seat control apparatus to obtain information about at least one of a starting state of the host vehicle, a driving speed of the host vehicle, an open/closed state of a door, or a combination thereof. Alternatively, the instructions, when executed by the control device, may cause the seat control apparatus to receive the information from an external device connected to the sensor device, by using the sensor device. Additionally, the instructions, when executed by the control device, may cause the seat control apparatus to determine whether the intent of the user identified based on the information satisfies the specified condition.

According to an embodiment, the instructions, when executed by the control device, may cause the seat control apparatus to identify that the user intends to get off the host vehicle. Additionally, the instructions, when executed by the control device, may cause the seat control apparatus to determine that the user's intent satisfies the specified condition, when at least one of a first case that the host vehicle is in a non-starting state, a second case that the host vehicle is not driving, a third case that the driving speed of the host vehicle is less than or equal to a specified speed, or a combination thereof is satisfied at the same time, and it is identified that a door corresponding to the seat is open.

According to an embodiment, the instructions, when executed by the control device, may cause the seat control apparatus to determine whether at least one of a current slide state of the seat, a current tilt state of the seat, a current legrest state of the seat, or a combination thereof is included in a specified area. Additionally, the instructions, when executed by the control device, may cause the seat control apparatus to allow at least one of the slide location of the seat, the tilt location of the seat, the legrest location of the seat, or a combination thereof, which is not included in the specified area, to be included in the specified area.

According to an embodiment, the instructions, when executed by the control device, may cause the seat control apparatus to control at least one of the slide location of the seat, the tilt location of the seat, the legrest location of the seat, or a combination thereof based on the state of the seat stored in the memory. This is achieved when it is identified that the user gets on the host vehicle again, by using an open/closed state of a door identified by using the sensor device after the user gets off the host vehicle.

According to an embodiment, the instructions, when executed by the control device, may cause the seat control apparatus to identify a slide state among the state of the seat stored in the memory. Additionally, the instructions, when executed by the control device, may cause the seat control apparatus to control the seat such that the slide location of the seat is the same as a slide location in the slide state.

According to an embodiment, the instructions, when executed by the control device, may cause the seat control apparatus to identify a tilt state and a legrest state among the state of the seat stored in the memory. Furthermore, the instructions, when executed by the control device, may cause the seat control apparatus to control the seat such that the tilt location of the seat and the legrest location of the seat are the same as the locations in the tilt state and legrest state stored in the memory, when tilt and legrest control is set to be in an on state when the user gets on the host vehicle.

According to an embodiment, the instructions, when executed by the control device, may cause the seat control apparatus to terminate control of the seat when the seat operates in a walk-in mode, when it is identified that an infant gets on the host vehicle, or when it is identified that there is an infant seat in the host vehicle.

According to an embodiment, the instructions, when executed by the control device, may cause the seat control apparatus to generate an absolute value of a control amount for controlling at least one of the slide location of the seat, the tilt location of the seat, the legrest location of the seat, or a combination thereof based on the state of the seat. Alternatively, the instructions, when executed by the control device, may cause the seat control apparatus to generate at least one of a target slide location of the seat, a target tilt location of the seat, a target legrest location of the seat, or a combination thereof based on the state of the seat. Additionally, the instructions, when executed by the control device, may cause the seat control apparatus to control the seat based on the generated result.

According to an embodiment, the seat control apparatus may further include a communication device. The instructions, when executed by the control device, may cause the seat control apparatus to generate a control amount for controlling the seat by using at least one of weather in an area near the host vehicle, precipitation in the area, snowfall in the area, an amount of rainwater in the area, external object information obtained by using the sensor device, or a combination thereof. The weather, the precipitation, the snowfall, or the amount of rainwater may be obtained by using the communication device. Additionally, the instructions, when executed by the control device, may cause the seat control apparatus to control the seat based on the generated control amount.

According to an aspect of the present disclosure, a seat control method includes: identifying, by a control device, an intent of a user getting on a host vehicle by using a sensor device; and identifying, by the control device, a state of a seat corresponding to the user, when the intent of the user satisfies a specified condition. The method also includes storing, by the control device, the identified state of the seat in a memory. Additionally, the method includes controlling, by the control device, at least one of a slide location of the seat, a tilt location of the seat, a legrest location of the seat, or a combination thereof by using a driving device based on the state of the seat.

According to an embodiment, the identifying, by the control device, of the state of the seat corresponding to the user when the intent of the user satisfies the specified condition may further include obtaining, by the control device, information about at least one of a starting state of the host vehicle, a driving speed of the host vehicle, an open/closed state of a door, or a combination thereof, or receiving the information from an external device connected to the sensor device, by using the sensor device. The identifying, by the control device, of the state of the seat corresponding to the user when the intent of the user satisfies the specified condition may also include determining, by the control device, whether the intent of the user identified based on the information satisfies the specified condition.

According to an embodiment, the identifying, by the control device, of the state of the seat corresponding to the user when the intent of the user satisfies the specified condition may further include: identifying, by the control device, that the user intends to get off the host vehicle; and determining that the user's intent satisfies the specified condition, when at least one of a first case that the host vehicle is in a non-starting state, a second case that the host vehicle is not driving, a third case that the driving speed of the host vehicle is less than or equal to a specified speed, or a combination thereof is satisfied at the same time, and it is identified that a door corresponding to the seat is open.

According to an embodiment, the controlling, by the control device, of the at least one of the slide location of the seat, the tilt location of the seat, the legrest location of the seat, or the combination thereof by using the driving device based on the state of the seat may further include: determining, by the control device, whether at least one of a current slide state of the seat, a current tilt state of the seat, a current legrest state of the seat, or a combination thereof is included in a specified area; and allowing, by the control device, at least one of the slide location of the seat, the tilt location of the seat, the legrest location of the seat, or a combination thereof, which is not included in the specified area, to be included in the specified area.

According to an embodiment, the controlling, by the control device, of the at least one of the slide location of the seat, the tilt location of the seat, the legrest location of the seat, or the combination thereof by using the driving device based on the state of the seat may further include controlling, by the control device, at least one of the slide location of the seat, the tilt location of the seat, the legrest location of the seat, or a combination thereof based on the state of the seat stored in the memory. This is achieved when it is identified that the user gets on the host vehicle again, by using an open/closed state of a door identified by using the sensor device after the user gets off the host vehicle.

According to an embodiment, the controlling, by the control device, of the at least one of the slide location of the seat, the tilt location of the seat, the legrest location of the seat, or the combination thereof by using the driving device based on the state of the seat may further include: identifying, by the control device, a slide state among the state of the seat stored in the memory; and controlling, by the control device, the seat such that the slide location of the seat is the same as a slide location in the slide state.

According to an embodiment, the controlling, by the control device, of the at least one of the slide location of the seat, the tilt location of the seat, the legrest location of the seat, or the combination thereof by using the driving device based on the state of the seat may include: identifying, by the control device, a tilt state and a legrest state among the state of the seat stored in the memory; and controlling, by the control device, the seat such that the tilt location of the seat and the legrest location of the seat are the same as locations in the tilt state and legrest state stored in the memory, when tilt and legrest control is set to be in an on state when the user gets on the host vehicle.

According to an embodiment, the seat control method may further include terminating, by the control device, control of the seat when the seat operates in a walk-in mode, when it is identified that an infant gets on the host vehicle, or when it is identified that there is an infant seat in the host vehicle.

According to an embodiment, the seat control method may further include generating, by the control device, an absolute value of a control amount for controlling at least one of the slide location of the seat, the tilt location of the seat, the legrest location of the seat, or a combination thereof based on the state of the seat. Alternatively, the method may include generating at least one of a target slide location of the seat, a target tilt location of the seat, a target legrest location of the seat, or a combination thereof based on the state of the seat. Additionally, the method may include controlling, by the control device, the seat based on the generated result.

According to an embodiment, the seat control method may further include generating, by the control device, a control amount for controlling the seat by using at least one of weather in an area near the host vehicle, precipitation in the area, snowfall in the area, an amount of rainwater in the area, external object information obtained by using the sensor device, or a combination thereof. The weather, the precipitation, the snowfall, or the amount of rainwater may be obtained by using the communication device. The seat control method may further include controlling, by the control device, the seat based on the generated control amount.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram showing components of a seat control apparatus, according to an embodiment of the present disclosure;

FIG. 2 is a conceptual diagram showing a configuration of a seat, according to an embodiment of the present disclosure;

FIG. 3 is a conceptual diagram illustrating an operation of a seat control apparatus, according to an embodiment of the present disclosure;

FIG. 4 is a conceptual diagram illustrating an operation of a seat according to the control of a seat control apparatus, according to an embodiment of the present disclosure;

FIG. 5 is a flowchart illustrating an operation of a seat control apparatus, according to an embodiment of the present disclosure;

FIG. 6 is a flowchart illustrating an operation of a seat control apparatus, according to an embodiment of the present disclosure;

FIG. 7 is a flowchart illustrating an operation of a seat control apparatus, according to an embodiment of the present disclosure; and

FIG. 8 illustrates a computing system related to a seat control method, according to an embodiment of the present disclosure.

With regard to the descriptions of the drawings, the same or similar components are marked by the same or similar reference signs.

### DETAILED DESCRIPTION

Hereinafter, some embodiments of the present disclosure are described in detail with reference to the accompanying drawings. In adding reference numerals to components of each drawing, it should be noted that the same components have the same reference numerals, although they are indicated on another drawing. Furthermore, in describing embodiments of the present disclosure, detailed descriptions associated with well-known functions or configurations are omitted when they may make the subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It should be understood that terms used herein should be interpreted as having a meaning that is consistent with their meaning in the context of the present disclosure and the relevant art. The terms should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

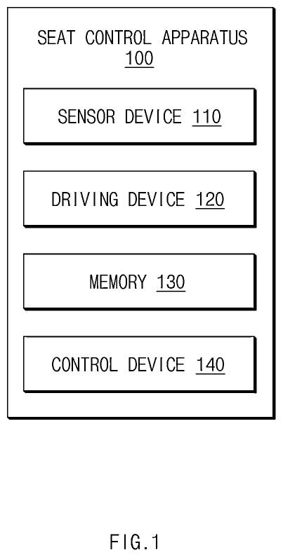

Hereinafter, various embodiments of the present disclosure are described in detail with reference to FIGS. 1-8.

FIG. 1 is a block diagram showing components of a seat control apparatus, according to an embodiment of the present disclosure.

According to an embodiment, a seat control apparatus 100 may include at least one of a sensor device 110, a driving device 120, a memory 130, a control device 140, or any combination thereof. The configuration of the seat control apparatus 100 shown in FIG. 1 is an example, and embodiments of the present disclosure are not limited thereto. The seat control apparatus 100 may further include components (e.g., at least one of an output device, a communication device, a driving device, an input device, an interface device, or any combination thereof) not shown in FIG. 1.

According to an embodiment, the sensor device 110 may obtain (or sense) various pieces of information used for driving a vehicle.

The sensor device 110 may include at least one sensor including at least one of a camera, a radar, a light detection and ranging (LiDAR), or any combination thereof.

The sensor device 110 may obtain information about an external object (e.g., at least one of a person, a burden, an obstacle, a structure, or any combination thereof) by using at least one sensor.

The sensor device 110 may obtain information about at least one of a rainwater sensor, a sensor configured to obtain various pieces of information about a host vehicle, or any combination thereof.

Furthermore, the sensor device 110 may obtain information about at least one of the starting states of the host vehicle, the driving speed of the host vehicle, the open-and-close state of at least part of a plurality of doors included in the host vehicle, or any combination thereof.

According to an embodiment, the driving device 120 may include at least one of a motor, an engine, or any combination thereof.

The driving device 120 may change a location (or state) of at least part of a plurality of seats provided in the host vehicle based on a control signal delivered from the control device 140.

For example, the driving device 120 may include at least one of a plurality of motors, a plurality of actuators, a plurality of gears, or any combination thereof, which correspond to a plurality of seats, respectively.

According to an embodiment, the memory 130 may store instructions or data. For example, the memory 130 may store one or more instructions that cause the seat control apparatus 100 to perform various operations when executed by the control device 140.

The memory 130 and the control device 140 may be implemented as one chipset. The control device 140 may include at least one of a communication processor or a modem.

The memory 130 may store information related to states and/or operations of components (e.g., at least one of an engine control unit (ECU), the sensor device 110, the control device 140, or any combination thereof) of the host vehicle.

The memory 130 may store various pieces of information related to the seat control apparatus 100. For example, the memory 130 may store information about the operation history of the control device 140.

The memory 130 may also identify a state of each of the plurality of seats included in a host vehicle at a specific time point.

According to an embodiment, the control device 140 may be operatively connected to the sensor device 110 and/or the memory 130. For example, the control device 140 may control the operation of the sensor device 110 and/or the memory 130.

The control device 140 may identify a user's intent (e.g., intent to get off the host vehicle) who has boarded (or is currently boarding) the host vehicle by using the sensor device 110.

The control device 140, by using the sensor device 110, may obtain information about at least one of the starting states of the host vehicle, the driving speed of the host vehicle, the opening/closing state of a door corresponding to a seat on which the user is sitting, or any combination thereof.

For example, when identifying that the host vehicle is in a non-starting state and a door corresponding to the seat on which the user is sitting is opened, the control device 140 may identify that the user has the intent to get off the host vehicle (i.e., get out of the host vehicle).

Furthermore, when identifying that the host vehicle is not driving (e.g., the driving speed is 0 km/h) and the door corresponding to the seat in which the user is sitting is opened, the control device 140 may identify that the user has the intent to get off the host vehicle.

When identifying that the driving speed is less than or equal to the specified speed (e.g., 3 km/h) and the door corresponding to the seat on which the user is sitting is open, it may be identified that the user has the intent to get off the host vehicle. In this case, the control device 140 may determine that the user's intent satisfies a specified condition.

The above-described embodiment is an example, and embodiments of the present disclosure are not limited thereto. For example, when identifying that a door corresponding to a seat in which the user is sitting is opened in a situation where at least one of the above-described conditions (e.g., a state where the host vehicle is not started, a state where the host vehicle is not driving, and a state where the driving speed of the host vehicle is less than or equal to a specified speed) is satisfied, the control device 140 may identify that the user has the intent to get off the host vehicle.

When the user's: intent satisfies the specified condition, the control device 140 may identify a state (e.g., a real-time state of the seat at a point in time when a door is opened) of the seat corresponding to the user.

The control device 140 may store the state of the identified seat in the memory 130. When the user gets on the host vehicle again later, the control device 140 may use the stored state of a seat to control the seat.

The control device 140 may control the seat by using the driving device 120.

For example, when it is determined that the user's intent satisfies the specified condition, the control device 140 may store the state of the seat in a memory. The control device 140 may then control at least one of a slide location of the seat, a tilt location of the seat, a legrest location of the seat, or any combination thereof based on the state of the seat by using the driving device 120.

The control device 140 may determine whether at least one of a current slide state of the seat, a current tilt state of the seat, a current legrest state of the seat, or any combination thereof, which is stored in the memory 130, is included in a specified area. The specified area may be a value capable of being changed by the user's settings or a setting value set at a point in time when a seat is installed for the first time. The specified area may include an area within a specific range (or distance or angle) based on a specific point within the host vehicle. For example, the control device 140 may identify a parameter, which is not included in the specified area, from among a plurality of parameters (e.g., a slide state, a tilt state, and a legrest state) included in the state of the seat. The control device 140 may control the identified parameter such that the identified parameter is included in the specified area. In other words, when it is identified that the slide state of the seat exceeds a specific value (e.g., 30 mm) based on the specific point, the control device 140 may control the slide location such that the slide location of the seat is changed within a specific value. Additionally, when it is identified that the tilt state of the seat exceeds a specific angle (e.g., 10 degrees) based on the specific point, the control device 140 may control the tilt location of the seat such that the tilt location is changed within a specific angle. Furthermore, when it is identified that the legrest state of the seat exceeds a specific angle (e.g., 25 degrees) based on the specific point, the control device 140 may control the legrest location of the seat such that the legrest location is changed within a specific angle. For example, when it is identified that the legrest state of the seat is less than a specific angle based on the specific point, the control device 140 may control the legrest location of the seat such that the legrest location is changed to a specified angle (e.g., 0 degrees).

The control device 140 may generate an absolute value of the control amount (e.g., a distance control amount for a slide location change, an angle control amount for a tilt location change, or an angle control amount for a legrest location change) for seat control based on the state of the seat. Additionally, the control device 140 may control the location of the seat based on the generated control amount.

The control device 140 may generate at least one of a target slide location, a target tilt location, a target legrest location, or any combination thereof for controlling the seat based on the state of the seat. Unlike an embodiment in which an absolute value is generated and a seat is controlled based on the absolute value, in this case, the control device 140 may control the seat until the generated target location.

The control device 140 may set priorities for controlling a slide location, a tilt location, and a legrest location. For example, after the control of the slide location of the seat is terminated, the control device 140 may terminate control of a tilt location and a legrest location together. Even after the slide location of the seat is terminated, the control device 140 may continuously control the tilt location and the legrest location.

After the control device 140 determines that a user has the intent to get off the host vehicle to control the seat as described above, the control device 140 may determine whether the user has the intent to get on the host vehicle again.

When it is identified that the user gets on (or intends to get on) the host vehicle again, by using an open/closed state of a door identified by using the sensor device 110 after the user gets off the host vehicle, the control device 140 may control at least one of a slide location of the seat, a tilt location of the seat, a legrest location of the seat, or any combination thereof based on the state of the seat stored in the memory 130.

The control device 140 may identify a slide state among seat states stored in the memory 130, and may control the seat such that the slide location of the seat is the same as the stored slide state. In other words, when the user gets off and gets on the host vehicle again, the control device 140 may omit the control of a tilt location or a legrest location, and may only control the slide location such that the slide location becomes the same as a location before the user gets off the host vehicle.

The control device 140 may also identify a tilt state and a legrest state among seat states stored in the memory 130. When the user's riding intent is identified, the control device 140 may control a tilt location and a legrest location based on the setting state of the tilt and legrest control. For example, when the tilt and legrest control is set to be in an on state when the user gets on the host vehicle, the control device 140 may control the seat such that the tilt location and the legrest location are the same as those in the tilt state and legrest state stored in the memory 130, while controlling the slide location.

Furthermore, even when it is determined that the user's intent satisfies a specified condition, based on at least one of an operating state of at least one of a plurality of seats of the host vehicle including a seat, a passenger state in the host vehicle, or any combination thereof, the control device 140 may not perform seat control or may terminate control of the seat midway.

For example, when at least one of a plurality of seats of a host vehicle including a seat that operates in a walk-in mode (or, when at least one of a plurality of seats is operating in real-time), when it is identified that an infant gets on the host vehicle, and/or when it is identified that there is an infant seat in at least one of a plurality of seats of the host vehicle, the control device 140 may terminate (or stop or not perform) control of the seat.

The components of the seat control apparatus 100 shown in FIG. 1 is an example, and embodiments of the present disclosure are not limited thereto. For example, the seat control apparatus 100 may further include a communication device (not shown).

According to an embodiment, the communication device may establish a communication channel (e.g., wireless communication channel) between the seat control apparatus 100 and an external device (e.g., an audio-video-navigation (AVN) device). Additionally, the communication device may support communication through the established communication channel. For example, the communication device may include one or more communication processors which are operated independently of the control device 140 (e.g., an application processor) and support direct (or wired) communication or wireless communication.

The communication device may also include a wireless communication module (e.g., a cellular communication module, a short-range wireless communication or module, a global navigation satellite system (GNSS) communication module) or a wired communication module (e.g., a local area network (LAN) communication module or a power line communication module). The corresponding communication module among these communication modules may communicate with an external device through a first network (e.g., a short-range communication network such as Bluetooth, wireless fidelity (WiFi) direct or infrared data association (IrDA)) or a second network (e.g., a legacy cellular network, 5G networks, next-generation communication networks, Internet, or telecommunication networks such as computer networks (e.g., LAN or WAN)) included in a network. The above-described kinds of communication modules may be integrated in one component (e.g., a single chip) or may be implemented with a plurality of components (e.g., a plurality of chips) which are independent of each other. Also, the communication device and the control device 140 may be implemented as a single chip.

The control device 140 may also communicate with an external device (e.g., an external controller distinct from the control device 140) by using the communication device. For example, the control device 140 may receive various pieces of information from an external device by using the communication device.

The control device 140 may also receive information, which is obtained by an external device connected to the sensor device 110 by using the sensor device 110, using the communication device. In other words, the control device 140 may obtain information about at least one of the starting states of the host vehicle, the driving speed of the host vehicle, the open/closed state of the door, or any combination thereof by using the sensor device 110. Alternatively, the control device 140 may receive the information, which is obtained by an external device connected to the sensor device 110 by using the sensor device 110, using a communication device.

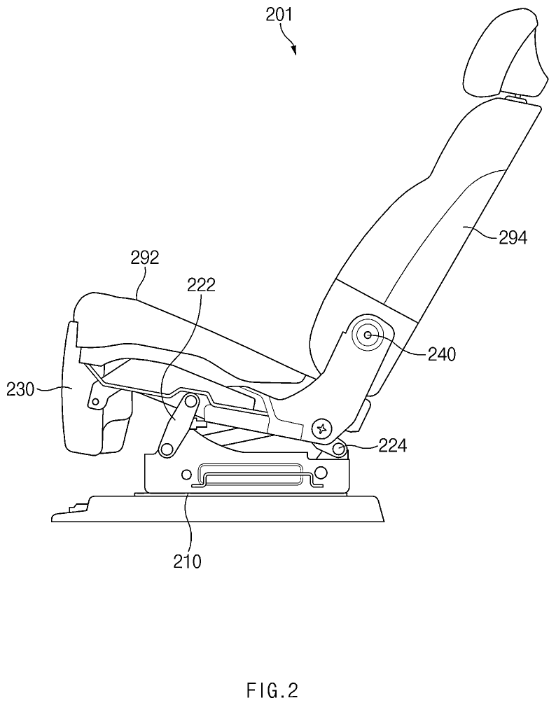

FIG. 2 is a conceptual diagram showing a configuration of a seat, according to an embodiment of the present disclosure.

According to an embodiment, a seat 201 may be changed to various locations based on the control of a seat control apparatus (e.g., the seat control apparatus 100 in FIG. 1). For example, the seat control apparatus may control a location of the seat 201 by using a driving device (e.g., the driving device 120 of FIG. 1).

The seat control apparatus 100 may control a slide location of the seat 201 by controlling a slide device 210. The seat control apparatus 100 may move the seat 201 to the left or right by using the slide device 210 in a direction in which the seat 201 illustrated in FIG. 2 is viewed.

The seat control apparatus 100 may also control a tilt location (e.g., an angle of a cushion 292 included in the seat 201) by controlling at least one tilt device 222 or 224. For example, the seat control apparatus 100 may move the cushion 292 of the seat 201 upward or downward by using the at least one tilt device 222 or 224 in a direction in which the seat 201 illustrated in FIG. 2 is viewed.

The seat control apparatus 100 may also control a location of a legrest 230 by using at least one driver device disposed adjacent to the legrest 230. The seat control apparatus 100 may move an end of the legrest 230 to an upper left side or a lower right side in a direction in which the seat 201 illustrated in FIG. 2 is viewed.

The seat control apparatus may also control a location of a seat backrest 294 by using a seat backrest driver device 240 disposed to adjust an angle of the seat backrest 294. The seat control apparatus 100 may move the seat backrest 294 to the right or left in a direction in which the seat 201 illustrated in FIG. 2 is viewed.

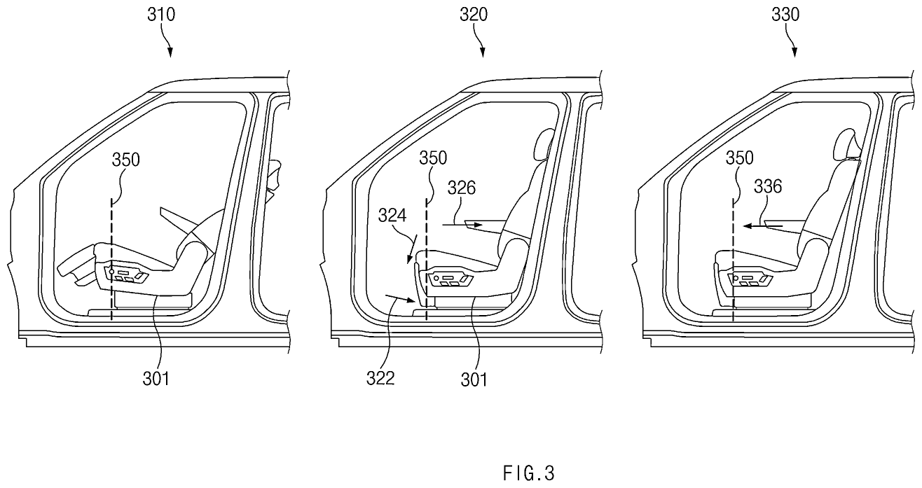

FIG. 3 is a conceptual diagram illustrating an operation of a seat control apparatus, according to an embodiment of the present disclosure.

Referring to reference number 310, according to an embodiment, a seat control apparatus (e.g., the seat control apparatus 100 of FIG. 1) may allow a seat 301 to be in a relaxation mode by using a driving device (e.g., the driving device 120 in FIG. 1). A relaxation mode may be defined as a combination of “relax,” which means that the user relaxes, and “position,” which means the posture of the seat. A relaxation mode may refer to an operation mode (or state) of a seat implemented so that the user may sit relatively comfortably and rest.

Based on a specified axis 350 of the seat 301, the relaxation mode may be an operating mode in which a reclining angle, a legrest angle, and a tilt angle of the seat 301 are larger than those in a general mode (e.g., a mode in which a vehicle that a user boards is moving, and the like). Additionally, in the relaxation mode, a slide location is moved to the front side of the host vehicle compared to the general mode.

Referring to reference number 320, according to an embodiment, when it is determined that the user has the intent to leave the seat 301 and get off the host vehicle, the seat control apparatus 100 may allow the seat 301 to be in a getting-off mode by using a driving device.

For example, based on the specified axis 350 of the seat 301, the getting-off mode may be an operating mode in which a reclining angle, a legrest angle, and a tilt angle of the seat 301 are smaller than those in the relaxation mode. Additionally, a slide location is moved further to the rear side of the host vehicle compared to the relaxation mode.

To control the location of the seat 301 from the relaxation mode to the getting-off mode, the seat control apparatus 100 may control a legrest location of the seat in a first direction 322. The seat control apparatus 100 may also control a tilt location of the seat in a second direction 324, and may control a slide location of the seat in a third direction 326.

Referring to reference number 330, according to an embodiment, the seat control apparatus 100 may allow the seat 301 to be in the getting-off mode. Afterward, when it is determined that the user has an intent to get on the host vehicle again and sit in the seat 301, the seat control apparatus 100 may allow the seat 301 to be in a getting-on mode by using the driving device.

For example, based on the specified axis 350 of the seat 301, the getting-on mode may be an operating mode in which a slide location of the seat 301 is relatively moved to the front side of the host vehicle compared to the getting-off mode according to reference number 320.

To control a location of the seat 301 from the getting-off mode to the getting-on mode, the seat control apparatus 100 may allow a slide location of the seat in a fourth direction 336.

Although not shown in FIG. 3, when controlling a location of the seat 301 from the getting-off mode to the getting-on mode, the seat control apparatus 100 may control the legrest location and/or tilt location together with the slide location. The legrest location and/or tilt location may be selectively controlled depending on the user's settings together with the control of the slide location.

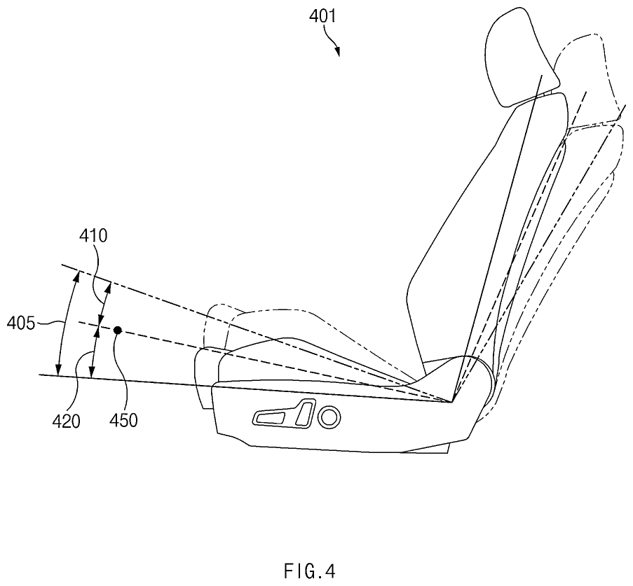

FIG. 4 is a conceptual diagram illustrating an operation of a seat according to a control of a seat control apparatus, according to an embodiment of the present disclosure.

According to an embodiment, a seat control apparatus (e.g., the seat control apparatus 100 in FIG. 1) may control a tilt location and/or legrest location of a seat 401 by using a driving device (e.g., the driving device 120 in FIG. 1). In FIG. 4, an embodiment in which a seat control apparatus 100 controls a tilt location of the seat 401 is shown. However, this is an example, and the embodiment may be applied to control a legrest location and/or slide location. The seat control apparatus 100 may selectively apply a control amount for controlling the seat 401.

The seat control apparatus 100 may identify a current state (e.g., at least one of a current slide state, a current tilt state, a current legrest state, or any combination thereof) of the seat 401. The seat control apparatus 100 may also control the location of the seat by a specified value (e.g., a specified distance or a specified angle) from a current state.

For example, the seat control apparatus 100 may allow a location of the seat 401 to move to a target location regardless of the current state of the seat 401. The seat control apparatus may allow the tilt location of the seat 401 to correspond to a target point 450. The target point 450 may correspond to an intermediate point of a tilt location range 405 controllable by the seat control apparatus 401.

The seat control apparatus 100 may also classify the controllable tilt location range 405 into a first section 410 and a second section 420 based on the target point 450.

For example, immediately before controlling the seat 401, when it is determined that the tilt location of the seat 401 is included in the first section 410, the seat control apparatus 100 may allow the tilt location of the seat 401 to correspond to the target point 450.

Furthermore, immediately before controlling the seat 401, when it is determined that the tilt location of the seat 401 is included in the second section 420, the seat control apparatus 100 may allow the seat 401 to correspond to the target point 450 or may not control a tilt location.

FIG. 4 illustrates that the target point 450 is a single target point. However, the target point 450 shown in FIG. 4 may be one of a plurality of target points set such that the seat control apparatus 100 controls the tilt location.

The seat control apparatus 100 may also identify a maximum point and a minimum point of the tilt location range 405 that is capable of being controlled. The seat control apparatus 100 may set a point between the two points as a target point.

Immediately before controlling the seat 401, when a tilt location of the seat 401 is included within any point between two points from the minimum point of the controllable tilt location range 405, the seat control apparatus 100 may control the tilt location of the seat 401 to the minimum point.

Furthermore, immediately before controlling the seat 401, when the tilt location of the seat 401 is included within one point between two points from the maximum point of the controllable tilt location range 405, the seat control apparatus 100 may control the tilt location of the seat 401 to the maximum point or any one point.

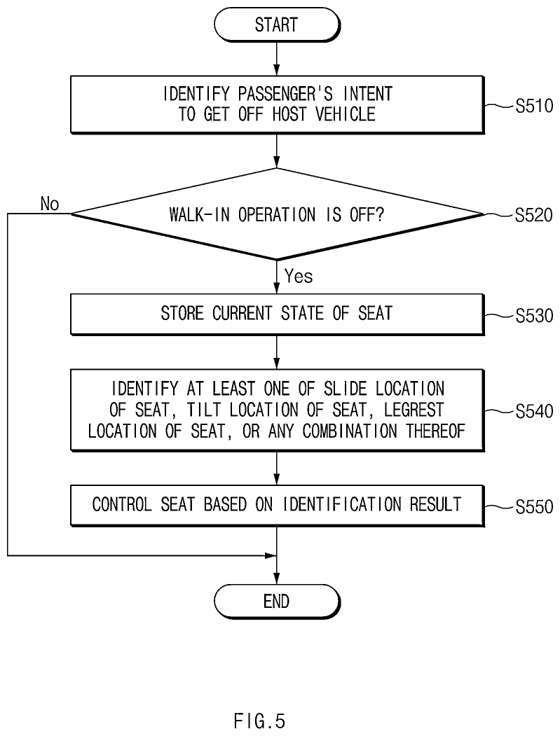

FIG. 5 is a flowchart illustrating an operation of a seat control apparatus, according to an embodiment of the present disclosure.

According to an embodiment, a seat control apparatus (e.g., the seat control apparatus 100 of FIG. 1) may perform the operations described in FIG. 5. For example, at least part of the components (e.g., at least one of the sensor device 110, the driving device 120, the memory 130, the control device 140, or any combination thereof) included in the seat control apparatus 100 may be configured to perform the operations of FIG. 5.

In the following embodiment, operations S510 to S550 may be sequentially performed, but are not always performed sequentially. For example, the order of operations may be changed, and at least two operations may be performed in parallel. Moreover, descriptions corresponding to or identical to the above-mentioned descriptions given with reference to FIG. may be briefly described or omitted to avoid redundancy.

According to an embodiment, the seat control apparatus 100 may identify a passenger's (or user's) intent to get off a host vehicle (S510).

The seat control apparatus 100 may identify that the user has the intent to leave a seat and to get off the host vehicle, by using at least one information obtained through a sensor device.

According to an embodiment, the seat control apparatus 100 may determine whether a walk-in operation is off (S520).

The seat control apparatus 100 may determine whether there is a seat in a walk-in operation among a plurality of seats included in the host vehicle.

For example, the walk-in operation may be of an operating type in which a front seat location of a specific seat is moved in a forward direction of the host vehicle such that the user may easily enter the specific seat.

When it is identified that at least one seat is in a walk-in operation OFF state (e.g., operation S520—Yes), the seat control apparatus 100 may perform operation S530.

When it is identified that the at least one seat is not in the walk-in operation OFF state (e.g., being in a walk-in operation ON state) (e.g., operation S520—No), the seat control apparatus 100 may end the procedure.

According to an embodiment, the seat control apparatus 100 may store a current state of the seat (S530).

When identifying the user's intent to get off the host vehicle, the seat control apparatus 100 may identify a seat state immediately before the user gets off the host vehicle, and may store the identified state in a memory.

According to an embodiment, the seat control apparatus 100 may identify at least one of a slide location of the seat, a tilt location of the seat, a legrest location of the seat, or any combination thereof (S540).

For example, the location information of the seat identified in operation S540 may be substantially the same information as the current state of the seat stored in the memory in operation S530.

According to an embodiment, the seat control apparatus 100 may control the seat based on the identification result (S550).

The seat control apparatus 100 may determine whether to control the seat based on whether the state of the seat is included in a specified area in which the user gets off the host vehicle.

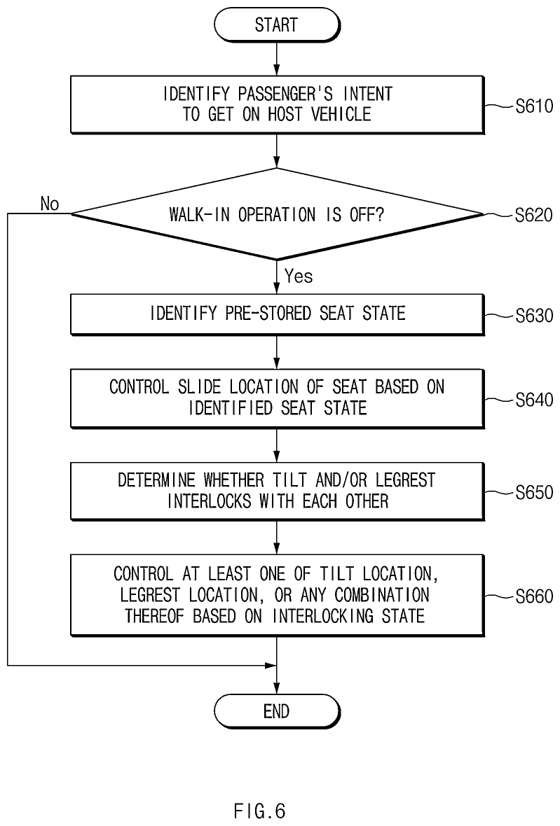

FIG. 6 is a flowchart illustrating an operation of a seat control apparatus, according to an embodiment of the present disclosure.

According to an embodiment, a seat control apparatus (e.g., the seat control apparatus 100 of FIG. 1) may perform the operations described in FIG. 6. For example, at least part of the components (e.g., at least one of the sensor device 110, the driving device 120, the memory 130, the control device 140, or any combination thereof) included in the seat control apparatus 100 may be configured to perform the operations of FIG. 6.

In the following embodiment, operations S610 to S660 may be sequentially performed, but are not always performed sequentially. The order of operations may be changed, and at least two operations may be performed in parallel. Moreover, descriptions corresponding to or identical to the above-mentioned descriptions given with reference to FIG. 6 may be briefly described or omitted to avoid redundancy.

For reference, the operations of FIG. 6 may be operations performed after all of the operations of FIG. 5 described above are performed. However, the embodiments of the present disclosure are not limited thereto.

According to an embodiment, the seat control apparatus 100 may identify a passenger's (or user's) intent to get on a host vehicle (S610).

The seat control apparatus 100 may identify that the user has the intent to get on the host vehicle and to sit in the seat, by using at least one information obtained through the sensor device.

According to an embodiment, the seat control apparatus 100 may determine whether a walk-in operation is off (S620).

The seat control apparatus 100 may also determine whether there is a seat in a walk-in operation among a plurality of seats included in the host vehicle.

For example, the walk-in operation may be of an operating type in which a front seat location of a specific seat is moved in a forward direction of the host vehicle such that the user may easily enter the specific seat.

When it is identified that at least one seat is in a walk-in operation OFF state (e.g., operation S620—Yes), the seat control apparatus 100 may perform operation S630.

When it is identified that the at least one seat is not in the walk-in operation OFF state (e.g., being in a walk-in operation ON state) (e.g., operation S620—No), the seat control apparatus 100 may end the procedure.

According to an embodiment, the seat control apparatus 100 may identify a pre-stored seat state (S630).

The seat control apparatus 100 may identify the state of the seat stored in the memory in operation S530 of FIG. 5.

According to an embodiment, the seat control apparatus 100 may control a slide location of the seat based on the identified seat state (S640).

The seat control apparatus 100 may identify a slide state among the seat states stored in the memory. The seat control apparatus 100 may control the seat such that the slide location of the seat is the same as a slide location in the slide state.

According to an embodiment, the seat control apparatus 100 may determine whether a tilt and/or legrest interlock with each other (S650).

For example, when performing a getting-on mode operation according to FIG. 6, the seat control apparatus 100 may identify a setting state regarding whether to control a tilt location and/or a legrest location together with the control of a slide location.

According to an embodiment, the seat control apparatus 100 may control at least one of the tilt location, the legrest location, or any combination thereof based on the interlocking state (S660).

For example, when it is identified that the settings for controlling a tilt location and/or a legrest location is ON when the seat control apparatus 100 performs the getting-on mode operation based on the setting state, the seat control apparatus 100 may control the tilt location and/or the legrest location after controlling the slide location or when simultaneously controlling the slide location.

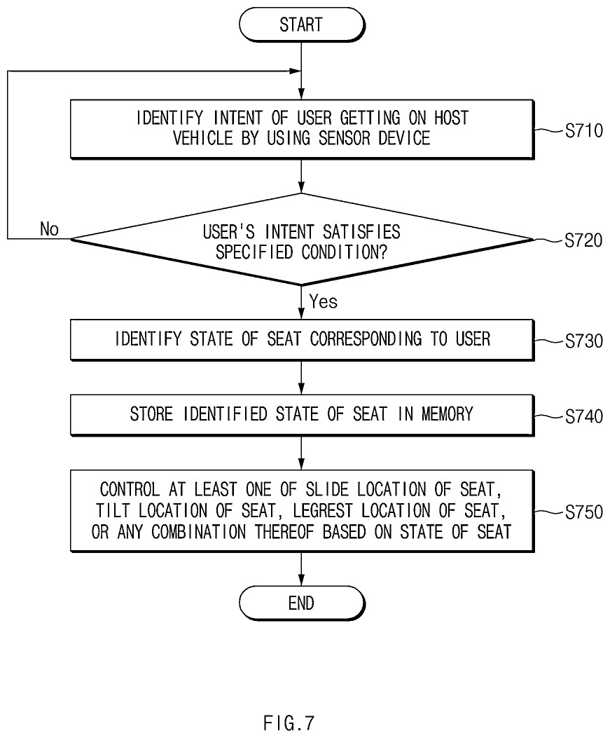

FIG. 7 is a flowchart illustrating an operation of a seat control apparatus, according to an embodiment of the present disclosure.

According to an embodiment, a seat control apparatus (e.g., the seat control apparatus 100 of FIG. 1) may perform operations described in FIG. 7. For example, at least part of the components (e.g., at least one of the sensor device 110, the driving device 120, the memory 130, the control device 140, or any combination thereof) included in the seat control apparatus 100 may be configured to perform the operations of FIG. 7.

In the following embodiment, operations S710 to S750 may be sequentially performed, but are not always performed sequentially. The order of operations may be changed, and at least two operations may be performed in parallel. Moreover, descriptions corresponding to or identical to the above-mentioned descriptions that are given with reference to FIG. 7 may be briefly described or omitted to avoid redundancy.

According to an embodiment, the seat control apparatus 100 may identify the intent of a user getting on a host vehicle by using a sensor device (S710).

The seat control apparatus may obtain information about at least one of a starting state of the host vehicle, a driving speed of the host vehicle, an open/closed state of a door, or any combination thereof.

The seat control apparatus 100 may identify the user's intent by using at least part of the information obtained by using the sensor device.

According to an embodiment, the seat control apparatus 100 may determine whether the user's intent satisfies a specified condition (S720).

For example, when it is identified that the starting state of the host vehicle is in an off state, the driving speed is a specified value (e.g., 0 km/h), and a door corresponding to a seat is open, the seat control apparatus 100 may identify that the user intends to get off the host vehicle. The seat control apparatus 100 may determine that the user's intent satisfies the specified condition.

When the user's intent satisfies the specified condition (e.g., operation S720—Yes), the seat control apparatus 100 may perform operation S730.

Furthermore, when the user's intent does not satisfy the specified condition (e.g., operation S720—No), the seat control apparatus 100 may repeat operation S710.

According to an embodiment, the seat control apparatus 100 may identify the state of the seat corresponding to the user (S730).

For example, the seat control apparatus 100 may identify a current state of the seat corresponding to the user in real-time immediately before controlling the seat.

According to an embodiment, the seat control apparatus 100 may store the identified state of the seat in a memory (S740).

According to an embodiment, the seat control apparatus 100 may control at least one of a slide location of the seat, a tilt location of the seat, a legrest location of the seat, or any combination thereof based on the state of the seat (S750).

The seat control apparatus 100 may determine whether at least one of a current slide state of the seat, a current tilt state of the seat, a current legrest state of the seat, or any combination thereof is included in a specified area.

The seat control apparatus 100 may allow at least one of a slide location of the seat, a tilt location of the seat, a legrest location of the seat, or any combination thereof, which is not included in the specified area, to be included in the specified area.

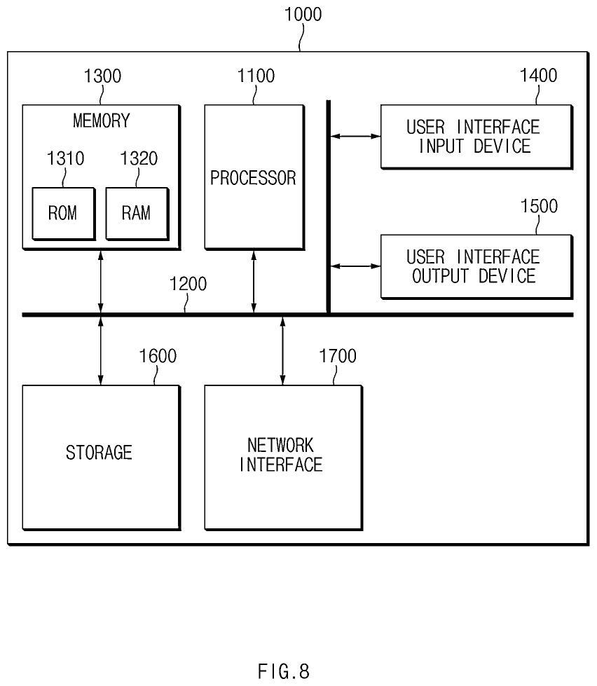

FIG. 8 illustrates a computing system related to a seat control method, according to an embodiment of the present disclosure.

Referring to FIG. 8, a computing system 1000 related to a seat control method may include at least one processor 1100, a memory 1300, a user interface input device 1400, a user interface output device 1500, a storage 1600, and a network interface 1700. The components of the computing system 1000 are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications may be made by those having ordinary skill in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of a seat control apparatus according to an embodiment of the present disclosure, and a method thereof are as follows.

According to at least one of embodiments of the present disclosure, a seat control apparatus may provide a user with a more convenient and easy exit experience by adaptively adjusting a tilt angle and legrest angle of the seat based on the user's intent.

Moreover, according to at least one of the embodiments of the present disclosure, when it is identified that the user got on the host vehicle again after getting off the host vehicle, optimal usability may be provided to the user by using a seat state before the user gets off the host vehicle.

Furthermore, according to at least one of the embodiments of the present disclosure, to prevent interference or disturbance between a plurality of seats included in the host vehicle, seat control may be stopped (or not started) by identifying that a part of the seat is performing a specific function (e.g., walk-in) or an infant (or an infant seat) is present.

According to at least one of the embodiments of the present disclosure, it is possible to provide a seat control apparatus that adaptively adjusts a seat control amount depending on a size of luggage through a sensor device including at least one of a camera, a LIDAR, or any combination thereof. Additionally, the seat control apparatus may obtain weather information the near host vehicle through the then adaptively adjust the seat communication device and control amount based on the weather information when a user gets on the host vehicle with luggage.

Furthermore, a variety of effects directly or indirectly understood through the present disclosure may be provided.

Hereinabove, although the present disclosure has been described with reference to embodiments and the accompanying drawings, the present disclosure is not limited thereto. Instead, the present disclosure may be variously modified and altered by those having ordinary skill in the art to which the present disclosure pertains without departing from the spirit and scope of the present disclosure claimed in the following claims.

What is claimed is:

1. A seat control apparatus, the apparatus comprising:
a sensor device;
a driving device;
a memory configured to store instructions; and
a control device electrically connected to the sensor device, the driving device, and the memory,
wherein instructions, when executed by the control device, cause the apparatus to:
identify an intent of a user getting on a host vehicle by using the sensor device;
identify a state of a seat corresponding to the user, when the intent of the user satisfies a specified condition;
store the identified state of the seat in the memory; and
control, by using the driving device based on the state of the seat, at least one of a slide location of the seat, a tilt location of the seat, a legrest location of the seat, or a combination thereof.

2. The apparatus of claim 1, wherein the instructions, when executed by the control device, further cause the apparatus to:
obtain information about at least one of a starting state of the host vehicle, a driving speed of the host vehicle, an open/closed state of a door, or a combination thereof, or receive the information from an external device connected to the sensor device, by using the sensor device; and
determine whether the intent of the user identified based on the information satisfies the specified condition.

3. The apparatus of claim 1, wherein the instructions, when executed by the control device, further cause the apparatus to:
identify that the user intends to get off the host vehicle, and
determine that the user's intent satisfies the specified condition, when at least one of a first case that the host vehicle is in a non-starting state, a second case that the host vehicle is not driving, a third case that the driving speed of the host vehicle is less than or equal to a specified speed, or a combination of the first case, the second case, and the third case is satisfied at the same time, and it is identified that a door corresponding to the seat is open.

4. The apparatus of claim 1, wherein the instructions, when executed by the control device, further cause the apparatus to:
determine whether at least one of a current slide state of the seat, a current tilt state of the seat, a current legrest state of the seat, or a combination thereof is included in a specified area; and
allow at least one of the slide location of the seat, the tilt location of the seat, the legrest location of the seat, or a combination thereof, which is not included in the specified area, to be included in the specified area.

5. The apparatus of claim 1, wherein the instructions, when executed by the control device, further cause the apparatus to:
control at least one of the slide location of the seat, the tilt location of the seat, the legrest location of the seat, or a combination thereof based on the state of the seat stored in the memory, when it is identified that the user gets on the host vehicle again, by using an open/closed state of a door identified by using the sensor device after the user gets off the host vehicle.

6. The apparatus of claim 5, wherein the instructions, when executed by the control device, further cause the apparatus to:
identify a slide state among the state of the seat stored in the memory; and
control the seat such that the slide location of the seat is the same as a slide location in the slide state.

7. The apparatus of claim 5, wherein the instructions, when executed by the control device, further cause the apparatus to:
identify a tilt state and a legrest state among the state of the seat stored in the memory; and
control the seat such that the tilt location of the seat and the legrest location of the seat are the same as locations in the tilt state and legrest state stored in the memory, when tilt and legrest control is set to be in an on state when the user gets on the host vehicle.

8. The apparatus of claim 1, wherein the instructions, when executed by the control device, further cause the apparatus to:
terminate control of the seat when the seat operates in a walk-in mode, when it is identified that an infant gets on the host vehicle, or when it is identified that there is an infant seat in the host vehicle.

9. The apparatus of claim 1, wherein the instructions, when executed by the control device, further cause the apparatus to:
generate an absolute value of a control amount for controlling at least one of the slide location of the seat, the tilt location of the seat, the legrest location of the seat, or a combination thereof based on the state of the seat, or generate at least one of a target slide location of the seat, a target tilt location of the seat, a target legrest location of the seat, or a combination thereof based on the state of the seat; and
control the seat based on the generated result.

10. The apparatus of claim 1, further comprising:
a communication device,
wherein the instructions, when executed by the control device, further cause the apparatus to:
generate a control amount for controlling the seat by using at least one of weather in an area near the host vehicle, precipitation in the area, snowfall in the area, an amount of rainwater in the area, external object information obtained by using the sensor device, or a combination thereof, wherein the weather, the precipitation, the snowfall, or the amount of rainwater is obtained by using the communication device; and
control the seat based on the generated control amount.

11. A seat control method, the method comprising:
identifying, by a control device, an intent of a user getting on a host vehicle by using a sensor device;
identifying, by the control device, a state of a seat corresponding to the user, when the intent of the user satisfies a specified condition;
storing, by the control device, the identified state of the seat in a memory; and
controlling, by the control device, at least one of a slide location of the seat, a tilt location of the seat, a legrest location of the seat, or a combination thereof by using a driving device based on the state of the seat.

12. The method of claim 11, wherein identifying the state of the seat corresponding to the user includes:
obtaining, by the control device, information about at least one of a starting state of the host vehicle, a driving speed of the host vehicle, an open/closed state of a door, or a combination thereof, or receiving the information from an external device connected to the sensor device, by using the sensor device; and
determining, by the control device, whether the intent of the user identified based on the information satisfies the specified condition.

13. The method of claim 11, wherein identifying the state of the seat corresponding to the user further includes:
identifying, by the control device, that the user intends to get off the host vehicle, and determining that the user's intent satisfies the specified condition, when at least one of a first case that the host vehicle is in a non-starting state, a second case that the host vehicle is not driving, a third case that the driving speed of the host vehicle is less than or equal to a specified speed, or a combination thereof is satisfied at the same time, and it is identified that a door corresponding to the seat is open.

14. The method of claim 11, wherein controlling the at least one of the slide location of the seat, the tilt location of the seat, the legrest location of the seat, or the combination thereof further includes:
determining, by the control device, whether at least one of a current slide state of the seat, a current tilt state of the seat, a current legrest state of the seat, or a combination thereof is included in a specified area; and
allowing, by the control device, at least one of the slide location of the seat, the tilt location of the seat, the legrest location of the seat, or a combination thereof, which is not included in the specified area, to be included in the specified area.

15. The method of claim 11, wherein controlling the at least one of the slide location of the seat, the tilt location of the seat, the legrest location of the seat, or the combination thereof further includes:
controlling, by the control device, at least one of the slide location of the seat, the tilt location of the seat, the legrest location of the seat, or a combination thereof based on the state of the seat stored in the memory, when it is identified that the user gets on the host vehicle again, by using an open/closed state of a door identified by using the sensor device after the user gets off the host vehicle.

16. The method of claim 11, wherein controlling the at least one of the slide location of the seat, the tilt location of the seat, the legrest location of the seat, or the combination thereof further includes:
identifying, by the control device, a slide state among the state of the seat stored in the memory; and
controlling, by the control device, the seat such that the slide location of the seat is the same as a slide location in the slide state.

17. The method of claim 15, wherein controlling the at least one of the slide location of the seat, the tilt location of the seat, the legrest location of the seat, or the combination thereof includes:
identifying, by the control device, a tilt state and a legrest state among the state of the seat stored in the memory; and
controlling, by the control device, the seat such that the tilt location of the seat and the legrest location of the seat are the same as locations in the tilt state and legrest state stored in the memory, when tilt and legrest control is set to be in an on state when the user gets on the host vehicle.

18. The method of claim 11, further comprising:
terminating, by the control device, control of the seat when the seat operates in a walk-in mode, when it is identified that an infant gets on the host vehicle, or when it is identified that there is an infant seat in the host vehicle.

19. The method of claim 11, further comprising:
generating, by the control device, an absolute value of a control amount for controlling at least one of the slide location of the seat, the tilt location of the seat, the legrest location of the seat, or a combination thereof based on the state of the seat, or generating at least one of a target slide location of the seat, a target tilt location of the seat, a target legrest location of the seat, or a combination thereof based on the state of the seat; and
controlling, by the control device, the seat based on the generated result.

20. The method of claim 11, further comprising:
generating, by the control device, a control amount for controlling the seat by using at least one of weather in an area near the host vehicle, precipitation in the area, snowfall in the area, an amount of rainwater in the area, external object information obtained by using the sensor device, or a combination thereof, wherein the weather, the precipitation, the snowfall, or the amount of rainwater is obtained by using a communication device; and
controlling, by the control device, the seat based on the generated control amount.
